(19) United States
(12) Patent Application Publication
(10) Pub. No.: US 2009/0175449 A1
(43) Pub. Date: Jul. 9, 2009

(54) WIRELESS NETWORK HANDOFF KEY

(75) Inventors: Fujio Watanabe, Sunnyvale, CA (US); Craig B. Gentry, Mountain View, CA (US); Gang Wu, Cupertino, CA (US); Toshiro Kawahara, Saratoga, CA (US)

Correspondence Address: Haynes and Boone, LLP;IP Section, 2323 Victory Avenue, SUITE 700, Dallas, TX, 75219, US

(73) Assignee: NTT DOCOMO, INC.

(21) Appl. No.: 12/402,363

(22) Filed: Mar. 11, 2009

Related U.S. Application Data
(62) Division of application No. 10/765,417, filed on Jan. 27, 2004.
(60) Provisional application No. 60/448,729, filed on Feb. 20, 2003.
(60) Provisional application No. 60/472,662, filed on May 22, 2003.

(51) Int. Cl. H04L 9/00

(52) U.S. Cl. 380/272

(57) ABSTRACT

The present invention provides a method and system for handoff in a wireless communication network. In one embodiment, a common handoff encryption key is generated by an authentication server and transmitted to a first access point and a second access point. The first access point transmits the handoff encryption key to a wireless terminal. The wireless terminal encrypts output data with the handoff encryption key. When the wireless terminal is associated with the second access point, the second access point decrypts data from the wireless terminal with the handoff encryption key. In a second embodiment, a handoff WEP key generation secret parameter is provided to a first and a second access point. Both access points generate a handoff WEP key as a function of the handoff WEP key generation secret parameter and an address of a wireless terminal. The first access point transmits the handoff WEP key to the wireless terminal. The second access point communicates data packets encrypted with the handoff WEP key with the wireless terminal.

### CROSS-REFERENCE TO RELATED APPLICATIONS

The present application is a division of U.S. patent application Ser. No. 10/765,417 filed on Jan. 27, 2004, incorporated herein by reference, which claims priority under 35 U.S.C. § 119(e) to Provisional Application No. 60/448,729, filed Feb. 20, 2003, and Provisional Application No. 60/472,662, filed May 22, 2003, all of which are incorporated herein by reference.

### FIELD OF THE INVENTION

The present invention relates generally to a wireless network environment, and more particularly to a method and system for providing a handoff key for a wireless network environment.

### BACKGROUND OF THE INVENTION

A wireless local area network (WLAN or wireless LAN) operates in some ways like a wired LAN, except that in a WLAN the transmission medium is radio waves rather than wires. In a typical WLAN topography, terminals communicate with a larger network, such as a wired LAN or wide area network (WAN), through access points. An access point is a terminal that acts as a gateway between the WLAN and the larger network.

In wired LANs, physical security can be used to prevent unauthorized access. However, physical security may be impractical in WLANs so an authentication process for network access and an encryption/decryption mechanism may be required.

Access points for WLANs may be located in places such as meeting rooms, restaurants, hallways, corridors, lobbies, and the like. A terminal accessing the WLAN may move out of the communication range of a first access point and into the communication range of a second access point. When this occurs, a handover (handoff) from the first access point to the second access point may be required to provide continuity of connectivity of the terminal to the WLAN.

Three types of terminal mobility within a WLAN are possible. The first type is “no transition” mobility. Two subclasses in this type of mobility are static and local. In static mobility, the terminal does not move at all. In local mobility, the terminal moves only within the range of one access point, that is, within a single BSS (Basic Service Set). There is no need for handoff.

A second type of WLAN mobility is BSS-transition mobility. In BSS-transition mobility, the terminal moves from a first access point (AP) to a second access point within the same extended service set (ESS). The third type of WLAN mobility is ESS-transition mobility. In ESS-transition mobility, the terminal moves from a first access point in a first ESS to a second access point in a second ESS. In either of these last two types of mobility, handoff may be necessary.

Generally, in a WLAN, a terminal must communicate terminal authentication packets with an authentication server, which may be a home registration server, before it may access the WLAN through the second access point. This authentication process could be time consuming, interrupting communications between the terminal and another terminal. This interruption could be problematic, especially for real-time applications, such as streaming applications and voice over IP (VoIP) applications, which require uninterrupted communications for smooth operation and quality of service (QoS) guarantees. Authentication also can prevent fast handoff between access points.

To address the issue of handoff speed, preauthentication may reduce authentication-processing time during terminal movement. The authentication service may be invoked independently of the association service to speed up reassociation. A station that is already associated with and authenticated to an access point may carry out this preauthentication. However, data transmission still has had to await authentication of the terminal.

It would be desirable to provide a method and system for quickly authenticating a terminal during a handoff. It would further be desirable to provide a method and system for maintaining security during such a fast handoff.

It also would be desirable to provide a method and system that allows temporary access for transmission of real-time data immediately after a handoff from a first access point to a second access point. It would be further desirable to provide a system and method that permits secure data transmission during such a fast handoff.

### SUMMARY OF THE INVENTION

In view of the foregoing and in accordance with various objects, a method and system for handoff in a wireless communication network is provided, in which, in one embodiment, an authentication server provides a common handoff encryption key to a first access point and a second access point. The first access point transmits the handoff encryption key to a wireless terminal. The wireless terminal may encrypt output data with the handoff encryption key. When the wireless terminal is associated with the second access point, the second access point decrypts data from the wireless terminal with the handoff encryption key, and transfers the decrypted data to a higher layer of the communication network before authentication of the wireless terminal is completed.

In another embodiment, a handoff key generation secret parameter is provided to a first and a second access point. Both access points generate a handoff key as a function of the handoff key generation secret parameter and an address of a wireless terminal. The first access point transmits the handoff key to the wireless terminal. The second access point communicates data packets encrypted with the handoff key with the wireless terminal.

The first access point may only transmit the handoff key to the wireless terminal if the wireless terminal is actively communicating via the first access point. The first access point may encrypt the handoff key with a session key before transmitting it to the wireless terminal.

In accordance with either of the foregoing embodiments, the handoff key or corresponding key generation information may be wired equipment privacy (WEP) key or key generation information, or Wi-Fi protected access (WAP) key or key generation information.

In accordance with another aspect of the invention, a wireless network may include a server that transmits a handoff key generation secret parameter to a first access point and a second access point. Both access points generate a handoff key as a function of the handoff key generation secret parameter and an address of a wireless terminal. The second access point receives encrypted data from the wireless terminal and decrypts it with the handoff key.

Other systems, methods, features and advantages of the invention will be, or will become apparent to one with skill in the art upon examination of the following figures and detailed description. The invention is not limited to the particular encryption technique employed.

### BRIEF DESCRIPTION OF THE DRAWINGS

FIG. 1 is a system-level block diagram of a distributed computing system in which the present invention can be used.

FIG. 2 is a block diagram of a sub-network 10 of FIG. 1, including a wireless segment.

FIG. 3 is a packet communication diagram for a shared key handoff procedure according to one embodiment of the present invention.

FIG. 4 is a packet communication diagram for an open system handoff procedure according to another embodiment of the present invention.

FIG. 5 is a flow chart for a parallel processing security procedure according to one embodiment of the present invention.

FIG. 6 is a flow chart for a serial processing security procedure according to one embodiment of the present invention.

FIG. 7 is a key generation process to create a single handoff key for a wireless terminal according to an embodiment of the present invention.

FIG. 8 is a packet communication diagram for a unique key handoff procedure according to an embodiment of the present invention.

FIG. 9 illustrates a procedure for decoding with an open parameter in a unique key handoff procedure according to an embodiment of the present invention.

FIG. 10 is a block diagram of a sub-network 10 of FIG. 1 including a wireless segment according to another embodiment of the present invention.

FIG. 11 is a packet communication diagram for a procedure to create and obtain a handoff key according to one embodiment of the present invention.

FIG. 12 illustrates a handoff key algorithm request frame and a handoff key algorithm response frame according to an embodiment of the present invention.

FIG. 13 illustrates a secret parameter update request frame and a secret parameter update response frame according to an embodiment of the present invention.

FIG. 14 illustrates a secret parameter update notice frame and a secret parameter update acknowledgement frame according to an embodiment of the present invention.

### DETAILED DESCRIPTION OF EMBODIMENTS

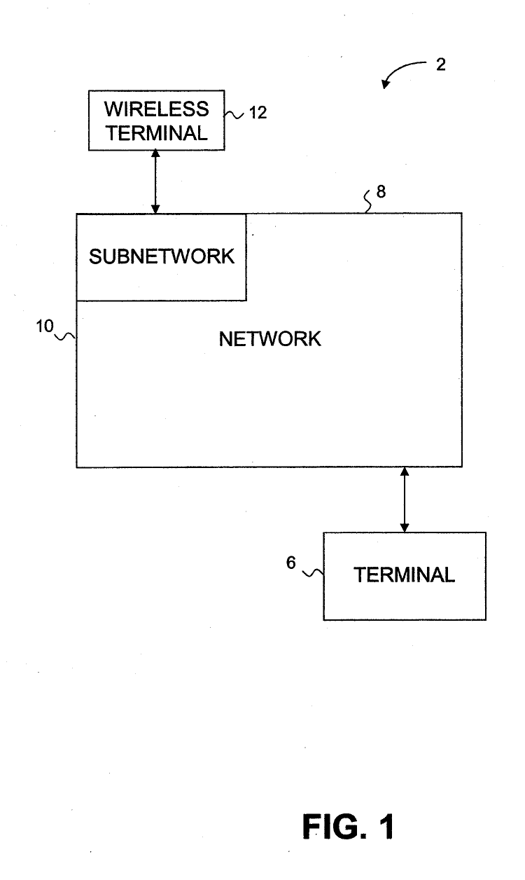

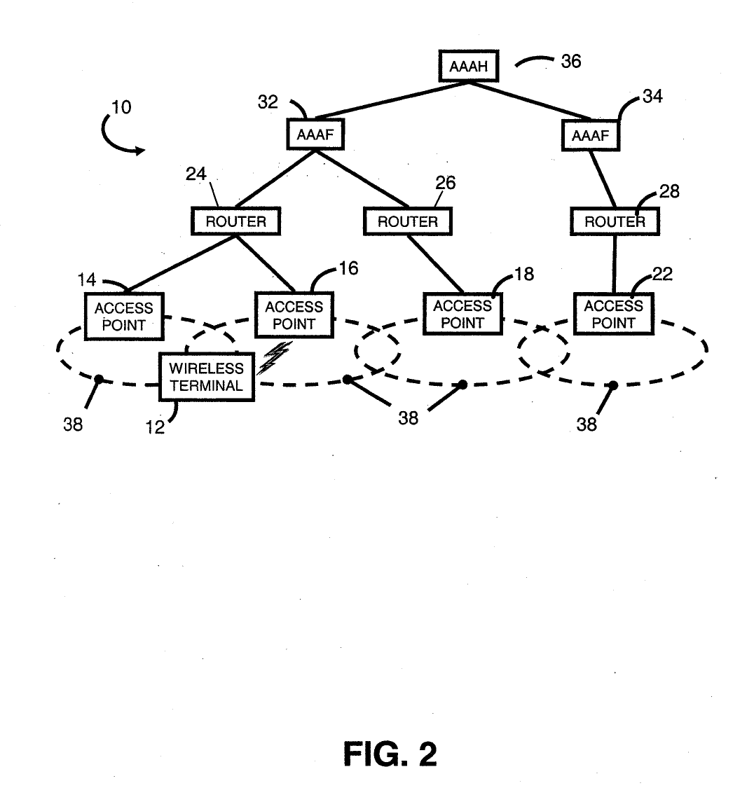

FIG. 1 is a system level block diagram of a distributed computing system 2 in which the present invention can be used. The distributed computing system 2 may be any computing environment where one or more terminals communicate with one or more other terminals. The configuration of the distributed computing system 2 shown in FIG. 1 is merely illustrative. The distributed computing system 2 includes: a wireless terminal 12, a network 8, and a terminal 6. The wireless terminal 12 may communicate with the terminal 6 via the network 8. The network 8 may be a global network, such as the Internet, a wide area network (WAN), or a local area network (LAN). The network 8 may include wireless communication networks, local area networks (LAN), wide area networks (WAN), satellite networks, Bluetooth networks, or other types of networks. The network 8 preferentially may include a sub-network 10. An illustrative sub-network 10 is shown in FIG. 2.

The terminal 6 and the wireless terminal 12 may be any of a desktop computer, a server, a laptop computer, a personal digital assistant (PDA), a pocket PC, a wireless telephone, or some other communications enabled device. The terminals 6 and 12 may each be configured as a client, as a server, or as a peer for peer-to-peer communications. Peer-to-peer communications may include voice over IP (VoIP), video teleconferencing, text messaging, file sharing, video streaming, audio streaming, or other direct communications. The terminals 6 and 12 may be capable of wireless communications, and may be coupled to the network 8 directly or through an access point. The terminal 6 and the wireless terminal 12 may each have a memory storing instructions for operation.

FIG. 2 is a block diagram of an illustrative sub-network 10 of the network 8 shown in FIG. 1. The sub-network 10 may include an authentication, authorization, and accounting home (AAAH) server 36; authentication, authorization, and accounting foreign (AAAF) servers 32 and 34; access routers 24, 26, and 28; and access points 14, 16, 18, and 22. Even though elements of the sub-network 10 are shown as directly coupled in FIG. 2, the elements may be indirectly coupled and separated geographically. The simplified coupling is shown in order to more clearly illustrate communication paths.

The AAAH server 36 may authenticate a set of terminals. This set of terminals may be associated with the AAAH server 36. The AAAH server 36 may have a memory storing code segments and instructions for operation. The AAAH server 36 may include an authentication server that maintains information regarding the identification, authorization, and billing of the associated terminals. The credentials or the identities of the associated terminals may be verified by the AAAH server 36. Also, whether the associated terminals are authorized to access a resource, such as a network, may be determined by the AAAH server 36.

A terminal authentication procedure may be used by the AAAH server 36. The terminal authentication procedure may use digital certificates, username and password pairs, or other challenge and response protocols that facilitate authenticating the associated terminals. As part of the terminal authentication procedure, the AAAH server 36 may communicate terminal authentication packets with the associated terminals and terminal authorization packets with authenticators. The terminal authentication packets may contain digital certificates, keys, usernames, passwords, challenge text, challenge messages, or the like to facilitate verifying the identity or credentials of the terminal. Terminal authorization packets may indicate that an associated terminal is authorized for a level of access to a resource, such as a network. The level of access may indicate full access, no access, or limited access.

The terminal authentication procedure may comply with the Remote Authentication Dial-In User Service (RADIUS) protocol specified in Internet Engineering Task Force (IETF) Request for Comments (RFCs) 2865 and 2866. The terminal authentication procedure also may comply with an authentication process specified in the IEEE 802.1x standard.

After authorizing an associated terminal, the AAAH server 36 may track (account for) resources utilized by the associated terminal. For example, the AAAH server 36 may track metrics regarding access of a network by the associated terminal. Information regarding resource utilization by an associated terminal may be provided to the AAAH server 36.

The AAAH server 36 may generate an encryption key. The encryption key may be a handoff key. In one embodiment, the handoff key is a WEP key. The term “handoff WEP key” or “handoff key” is used herein for an encryption key that may be used simultaneously by more than one access point for encrypted communications with one or more wireless terminals.

The AAAH server 36 may provide handoff keys to access points. During a handoff of a terminal from a first access point to a second access point, communications between the terminal and the second access point may be encrypted by a handoff key. The AAAH server 36 may generate and provide new handoff keys with a frequency adequate for reasonably secure communications.

The AAAF servers 32 and 34 may also authenticate sets of terminals. The AAAF servers 32 and 34, however, may be associated with different sets of terminals than the set associated with the AAAH server 36. For terminals associated with the AAAH server 36, the AAAH server 36 is the “home server”, and the AAAF servers 32 and 34 are “foreign servers”.

For terminals associated with the AAAF server 32, the AAAF server 32 is the “home server” and the AAAH server 36 is the “foreign server”. For clarity, the names of the servers have been chosen according to their relationship with the illustrative wireless terminal 12. Foreign servers are discussed to illustrate the versatility of the present invention, not to limit it.

The AAAF servers 32 and 34 may indirectly authenticate terminals associated with the AAAH server 36. The AAAF servers 32 and 34 may each have a memory storing code segments and instructions for operation. The AAAF servers 32 and 34 may have no innate information regarding the identities of terminals associated with the AAAH server 36. Nevertheless, the AAAF servers 32 and 34 may indirectly authenticate and authorize terminals associated with the AAAH server 36 by communicating terminal authentication packets and terminal authorization packets with the AAAH server 36. The AAAF servers 32 and 34 may account for resources utilized by terminals associated with the AAAH server 36, and provide accounting information to the AAAH server 36.

Each AAAF server 32 and 34 may generate handoff keys. Each AAAF server 32 and 34 may generate handoff keys for access points associated therewith. Alternatively, the AAAF server 32 and 34 may receive a common handoff key from the AAAH server 36.

The access routers 24, 26, and 28 may route packets. Each access router 24, 26, and 28 may be capable of determining a next network node to which a received packet should be forwarded. A network node may be a terminal, a gateway, a bridge, or another router. Each access router 24, 26, and 28 may be coupled to other sub-networks (not shown) and provided routes for packets between the sub-network 10 and other sub-networks.

Each access point 14, 16, 18, and 22 may provide access to a network. A memory storing code segments and instructions for operation may be included in each access point 14, 16, 18, and 22. Access points 14, 16, 18, and 22 may be edge points of a network. Each access point 14, 16, 18, and 22 may be an authenticator, and may require a terminal to be authenticated by an authentication server in order for the terminal to access the network. Before a terminal has been authenticated by an authentication server, the access points 14, 16, 18, and 22 may only allow the terminal to communicate terminal authentication packets with an authentication server. After the terminal has been authenticated by an authentication server, the access points 14, 16, 18, and 22 may allow the terminal to communicate data packets via the network.

The access points 14, 16, 18, and 22 may each include a wireless access port having an associated spatial coverage area 38. The coverage area 38 of each access point 14, 16, 18, and 22 may overlap with the coverage area 38 of one or more adjacent access points 14, 16, 18, and 22. Wireless terminals within the coverage area 38 of an access point 14, 16, 18, or 22, may associate with and communicate with the respective access point.

Encryption keys may be provided by access points 14, 16, 18, and 22 to wireless terminals within the coverage area 38 of the respective access point 14, 16, 18, and 22. Each encryption key may be a session key. A session key may be a wired equivalent privacy (WEP) key. The term “session WEP key” or “session key” is used herein for an encryption key that may be used for encrypted communications between an access point and a wireless terminal. Access points 14, 16, 18, and 22 may generate and provide session keys in compliance with the IEEE 802.11 standard. The procedure for generating a handoff key may be the same as that for generating a session key.

Each access point 14, 16, 18, or 22 may be operable to handoff a terminal to another access point 14, 16, 18, or 22 (handoff access point). During a handoff of a wireless terminal, the handing off access point 14, 16, 18 or 22 may provide a handoff key to the wireless terminal. For security reasons, the access points 14, 16, 18, and 22 may deliver a handoff key only to wireless terminals that are “actively” communicating at the time of a handoff. Actively communicating may include running a real-time application, such as a streaming video application or a VoIP application, downloading a file, or otherwise sending or receiving packets. If a terminal is merely associated with an access point 14, 16, 18, or 22 at the time of a handoff, then a handoff WEP key may not be provided to the terminal.

During a handoff of a terminal to one of the access points 14, 16, 18, or 22, the access point and the terminal may exchange handoff authentication messages. An illustrative handoff authentication message exchange is shown in Table 1.

TABLE 1

| Wireless Terminal | Handoff Access Point |
|---|---|
| Terminal Identity Assertion | |
| Auth. Algorithm ID = “handoff WEP” | |
| Auth. transaction sequence number = 1 | |
| Auth. algorithm dependent information = (none) | |
| | Auth. Algorithm ID = “handoff WEP” |
| | Auth. transaction sequence number = 2 |
| | Auth. algorithm dependent information = |
| | challenge text. |
| | Result of the requested authentication |
| Auth. Algorithm ID = “handoff WEP” | |
| Auth. transaction sequence number = 3 | |
| Auth. algorithm dependent information = | |
| challenge text encrypted by handoff WEP key | |
| | Auth. Algorithm ID = “handoff WEP” |
| | Auth. transaction sequence number = 4 |
| | Auth. algorithm dependent information = |
| | the authentication result |

The messages shown in Table 1 are used for handoff authentication. The Authentication Algorithm ID for each of the four messages is “handoff WEP”. A wireless terminal 12 transmits to a handoff access point 16 a first message, whose Authentication Transaction Sequence Number is 1, to request Authentication Algorithm Dependent Information. The first message also includes Terminal Identity Assertion, providing the access point 16 with identity information of the wireless terminal 12.

The handoff access point 16 then transmits to the wireless terminal 12 a second message, whose Authentication Transaction Sequence Number is 2. The second message includes the result of the handoff authentication. When the handoff authentication is successful, the second message also includes the requested Authentication Algorithm Dependent Information, in this case, the challenge text for association of the wireless terminal 12 and the handoff access point 16.

Next, the wireless terminal 12 transmits a third message, whose Authentication Transaction Sequence Number is 3. If the handoff authentication is successful, the third message includes the challenge text encrypted by the handoff WEP key.

Finally, the handoff access point 16 transmits a fourth message, whose Authentication Transaction Sequence Number is 4, indicating the exchange of handoff authentication messages has been finished.

Each handoff authentication message may include an authentication algorithm number to indicate an authentication algorithm for processing the message. For example, “2” may indicate a handoff WEP key algorithm, “1” may indicate a shared key (session key) algorithm, and “0” may indicate an open system (null authentication) algorithm. For the handoff WEP key algorithm, a handoff WEP key may be used to encrypt and decrypt challenge text.

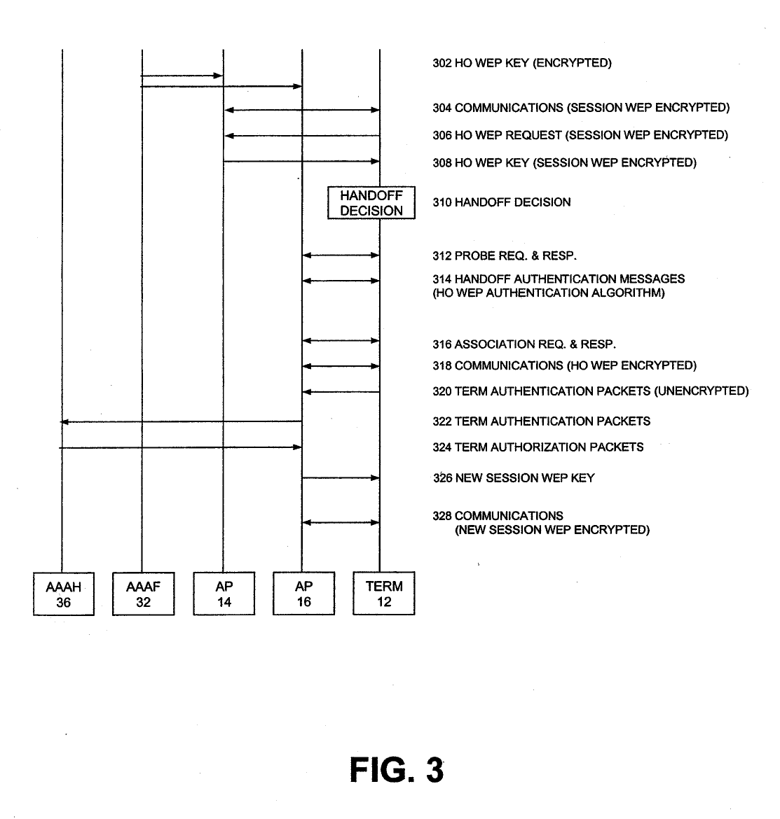

FIG. 3 shows a shared key handoff authentication procedure using a handoff WEP key according to one embodiment of the present invention. The access points 14 and 16 are both associated with the AAAF server 32. Therefore, access points 14 and 16 may receive a common handoff WEP key from the AAAF server 32 at 302. The handoff WEP key transmission may be encrypted by an encryption key shared by the AAAF server 32 and the access points 14 and 16. At 304, the wireless terminal 12 is in association with and communicating through the access point 14. Communication between the wireless terminal 12 and the access point 14 may be encrypted by a session WEP key.

To facilitate a quick handoff, the wireless terminal 12 may request a handoff WEP key at 306. The access point 14 may deliver the handoff WEP key to the wireless terminal 12 at 308. The access point 14 may deliver the handoff WEP key securely by encrypting it with the session WEP key. Rather than transmitting the actual handoff WEP key, the access point 14 may deliver a seed to generate the handoff WEP key.

The wireless terminal 12 may decide to handoff from the access point 14 to the access point 16 (handoff access point) at handoff decision 310. To begin the handoff, the wireless terminal 12 may exchange probe request and response packets with the handoff access point 16 at 312. If the probe is successful, then at 314 the wireless terminal 12 may exchange handoff authentication messages with the handoff access point 16. The handoff authentication message exchange at 314 may transpire as described above in Table 1.

If the handoff authentication is successful, then at 316 the wireless terminal 12 may exchange association request and response packets with the handoff access point 16. If successful, then at 316 the wireless terminal 12 may be associated with the handoff access point 16. After the wireless terminal 12 and the handoff access point 16 are associated, data communicated between them at 318 may be encrypted with the handoff WEP key. The wireless terminal 12 and the handoff access point 16 may continue to communicate data encrypted by the handoff WEP key until the handoff access point 16 provides a new session WEP key at 326.

For example, the wireless terminal 12 may require a new mobile internet protocol (IP) address in order to communicate via the Internet after association with the handoff access point 16. The handoff WEP key may be used at 318 to encrypt packets relating to mobile IP address acquisition. Illustratively, the wireless terminal 12 may communicate with a dynamic host control protocol (DHCP) server (not shown) at 318 in order to request and receive a new mobile IP address. The wireless terminal 12 may also send a binding update message at 318 that indicates the new mobile IP address. The handoff WEP key may provide sufficient security for packets relating to mobile IP address acquisition.

As a further example, the wireless terminal 12 may be running a real-time application at the time of the handoff. At 318, data packets sent and received by the real-time application may be encrypted by the handoff WEP key for communication via the handoff access point 16. Thus, the real-time application of the wireless terminal 12 may continue communicating with no perceivable interruption during the handoff.

At 320, the wireless terminal 12 may communicate terminal authentication packets to the handoff access point 16. The terminal authentication packets may be encrypted by the handoff WEP key. However, it may not be necessary to encrypt the terminal authentication packets.

At 322, the handoff access point 16 may communicate the terminal authentication packets to the AAAH server 36. After the AAAH server 36 verifies the identity or credentials of the wireless terminal 12, at 324 the AAAH server 36 may communicate terminal authorization packets to the handoff access point 16. The handoff access point 16 may provide a new session WEP key to the wireless terminal 12 at 326.

At 328, the wireless terminal 12 and the handoff access point 16 may switch from using the handoff WEP key to using the new session WEP key for encryption. The new session WEP key may be used to encrypt communications between the wireless terminal 12 and the handoff access point 16 until another handoff occurs, or communications cease for some other reason.

The shared key handoff authentication procedure described above may also be used for a handoff of the wireless terminal 12 from access point 16 to access point 18. With one additional action, this procedure may further be used for a handoff of the wireless terminal 12 from access point 18 to access point 22. In this one additional action, the AAAH server 36 may generate and provide the handoff WEP key to the AAAF severs 32 and 34, or directly to the access points 14, 16, 18 and 22. This action provides a common handoff WEP key to access points 18 and 22.

Other methods of generating and communicating a handoff WEP key may be implemented without departing from the scope of the claimed invention. For example, the AAAF sever 32 may generate the handoff WEP key, and communicate it to the AAAH server 36. The AAAH server 36 may then communicate the handoff WEP key to the AAAF sever 34. The methods described herein are merely illustrative.

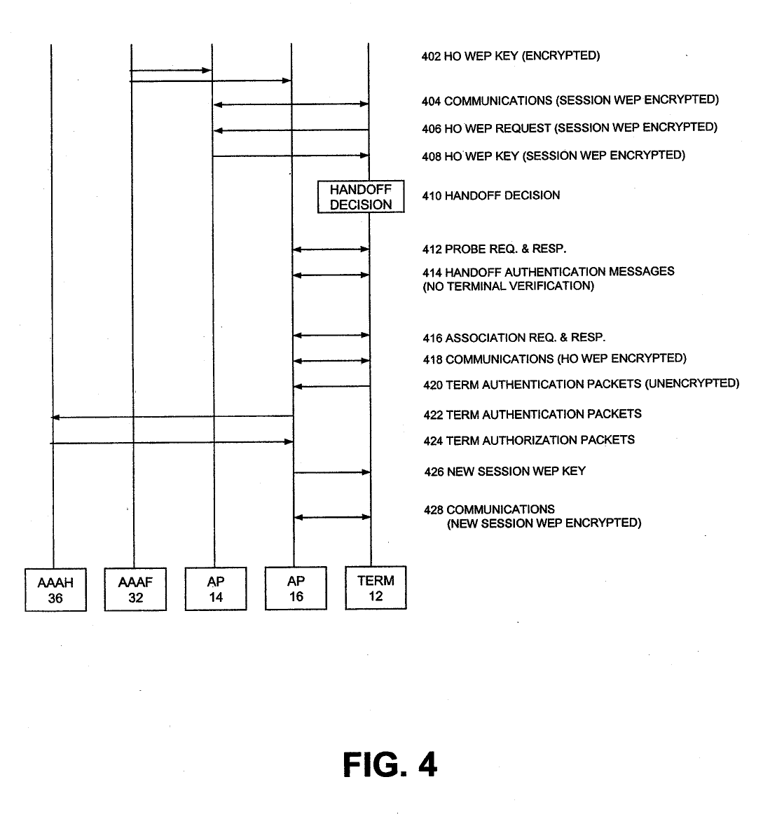

The shared key handoff authentication procedure shown in FIG. 3 may require a firmware modification for use by some existing equipment. Therefore, an open system handoff authentication procedure is provided in FIG. 4. The open system handoff authentication procedure may comply with the IEEE 802.11 standard, and further may comply with the IEEE 802.1x standard.

Many items of the open system handoff authentication procedure may operate in essentially the same manner as items in the shared key handoff authentication procedure. Items 402, 404, 406, 408, 410, and 412 of the open system handoff authentication procedure may operate in the same manner as items 302, 304, 306, 308, 310, and 312 in the shared key handoff authentication procedure, respectively. At 414, however, the handoff authentication message exchange may use an “open system” authentication algorithm rather than the “handoff WEP key” authentication algorithm used at 314.

Using the open system authentication algorithm, the handoff access point 16 may authenticate the wireless terminal 12 for handoff without a challenge (a null authentication). After this null authentication, at 416 the wireless terminal 12 may associate with the handoff access point 16. Data packets communicated between the wireless terminal 12 and the handoff access point 16 at 418 may be encrypted by the handoff WEP key.

At step 420, the wireless terminal 12 may communicate terminal authentication packets to the handoff access point 16. As in 320 above, the terminal authentication packets may be encrypted by the handoff WEP key at 420. Again, however, encryption of the terminal authentication packets may not be necessary. At 422, 424, 426, and 428, the open system handoff authentication procedure may operate in essentially the same manner as the shared key handoff authentication procedure at 322, 324, 326, and 328, respectively.

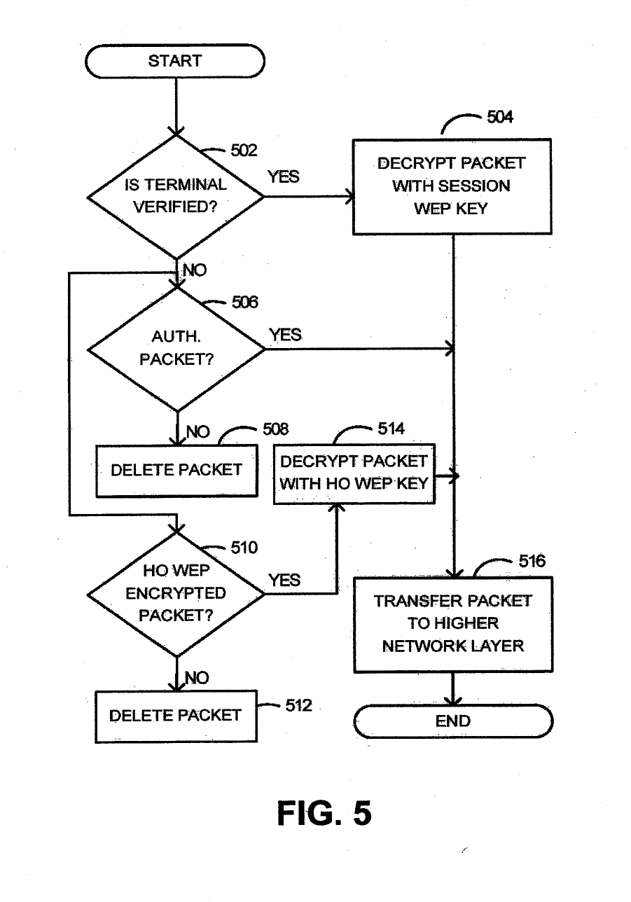

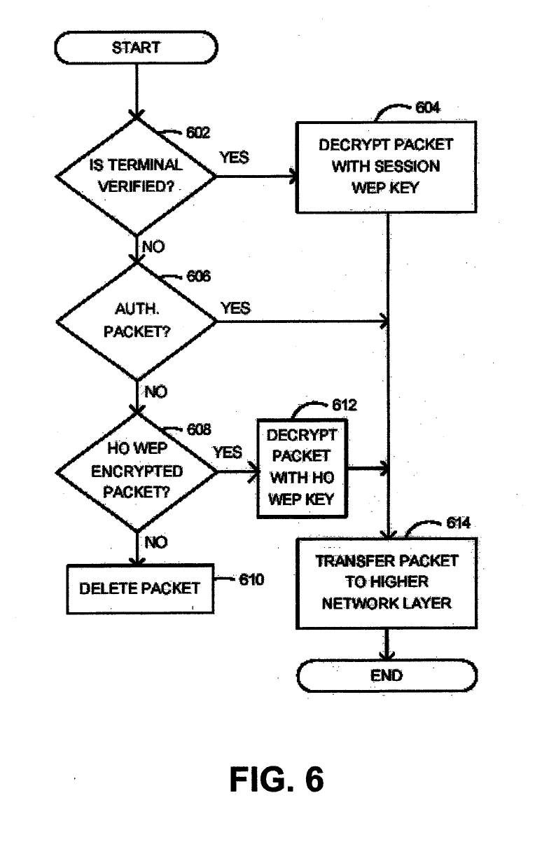

The open system authentication procedure may not challenge the wireless terminal 12 at 414. Therefore, the handoff access point 16 may include a security procedure that allows the wireless terminal 12 to communicate unencrypted terminal authentication packets to the AAAH server 36. Furthermore, the security procedure may allow the wireless terminal 12 to communicate data packets to the network 8 only if the data packets are encrypted with the handoff WEP key. Illustrative security procedures are shown in FIGS. 5 and 6.

FIG. 5 shows one security procedure for the handoff access point 16 according to one embodiment of the present invention. The security procedure may operate at a data link layer of the handoff access point 16. The security procedure may delete unauthorized packets, while transferring packets from verified media access control (MAC) addresses, terminal authentication packets, and handoff WEP encrypted packets to a higher network layer. When a packet is transferred to a higher network layer, it may continue on toward a destination node.

The handoff access point 16 may register MAC addresses of wireless terminals that are verified and have an associated session WEP key. The handoff access point 16 may receive a packet from the wireless terminal 12. At 502, the handoff access point 16 may determine from an origination MAC address of the packet whether the wireless terminal 12 is verified. If so, then the handoff access point 16 will have a session WEP key for the wireless terminal 12. The session WEP key may be used to decrypt the received packet at 504. The decrypted packet may then be transferred to a higher network layer at 516.

On the other hand, if the wireless terminal 12 is not verified, then at 506 and 510 the packet may be further analyzed. At 506, the handoff access point 16 may determine whether the packet is an unencrypted terminal authentication packet destined for the AAAH 36. If so, then packet may then be transferred to a higher network layer at 516. If not, then the packet may be deleted at 508.

At 510, the handoff access point 16 may determine whether the packet is encrypted by the handoff WEP key. If so, then packet may be decrypted at 514. The decrypted packet may then be transferred to a higher network layer at 516. If the packet is not encrypted by the handoff WEP key, then the packet may be deleted at 512.

By operation of the security procedure, packets encrypted by the handoff WEP key may be transferred to a higher network layer. Likewise, unencrypted terminal authentication packets may be transferred to a higher network layer. All other packets, including unencrypted or improperly encrypted data packets, may be deleted.

FIG. 6 shows another security procedure for the handoff access point 16 according to one embodiment of the present invention. There is one main difference between the security procedure shown in FIG. 6 and the one shown in FIG. 5. In the security procedure shown in FIG. 6, the received packet is processed serially rather than in parallel. Items 602 and 604 operate in essentially the same way as items 502 and 504, respectively. If the MAC address has not been verified, then the handoff access point 16 may proceed from 602 to 606.

At step 606, the handoff access point 16 may determine whether the packet is an unencrypted terminal authentication packet bound for the AAAH 36. If so, then the packet may be transferred to a higher network layer at 614. If not, at 608 the handoff access point 16 may determine whether the packet is encrypted by the handoff WEP key.

If the packet is encrypted by the handoff WEP key, then at 612 the packet may be decrypted. The decrypted packet may be transferred to a higher network layer at 614. If the packet is not encrypted by the handoff WEP key, then at 610 the packet may be deleted. As with the security procedure of FIG. 5, packets encrypted by the handoff WEP key and unencrypted terminal authentication packets may be transferred to a higher network layer, while all other packets may be deleted.

The open system handoff authentication procedure shown in FIG. 4 may implement the security procedure shown in FIG. 5 or the security procedure shown in FIG. 6. In either case, the open system handoff authentication procedure may operate with a wireless terminal 12 that does not support a handoff WEP key authentication algorithm.

For example, even though such a wireless terminal 12 may not accept a handoff WEP key at 408, it may still probe, be handoff authenticated by, and be associated with the handoff access point 16 at 410, 412, and 414. At 416, the wireless terminal 12 may not communicate data packets because it has no handoff WEP key with which to encrypt them. Any unencrypted data packets the wireless terminal 12 sends to the handoff access point 16 may be deleted by operation of the security procedures shown in FIG. 5 or FIG. 6.

Unencrypted terminal authentication packets from the wireless terminal 12, however, may still be communicated to the AAAH server 36. Therefore, the AAAH server 36 may still authenticate and authorize the wireless terminal 12. Consequently, the handoff access point 16 may still provide the wireless terminal 12 with a new session WEP key at 424, thereby allowing for encrypted data communications at step 426.

Another embodiment of the present invention will now be described. In the above embodiments of the invention, a single handoff WEP key is distributed, for example, by the AAAF server 32 to access points 14, 16, and 18. In effect, the access points 14, 16, and 18 share one handoff WEP key for all wireless terminals 12 where the sub-network 10 includes more than one wireless terminal 12. If this handoff WEP key is compromised by a denial of service (DoS) attack, then communication security for the wireless terminal 12 may be degraded. Specifically, because the handoff WEP key is shared, the compromise of the WEP handoff key may lead to the compromise of data communicated during a handoff.

To minimize this security degradation, the handoff WEP key may be frequently changed. This re-keying may be done securely because only when the terminal 12 is actively communicating may it handoff from, for example, access point 14 to access point 16. Therefore, the terminal 12 may receive a renewed handoff WEP key from the current access point 14. In addition, the handoff WEP key may be limited to use only during the handoff time, which should only be a few seconds. Therefore, the probability of compromise of communications between the wireless terminal 12 and the AP 16 is low.

To further minimize the possibility of compromise, a separate handoff WEP key may be used for each wireless terminal 12. As in the above embodiments, each handoff WEP key is valid until the wireless terminal 12 is authenticated by the AAAH server 12. Once the authentication of the wireless terminal 12 is complete, a session WEP key is created to encrypt data transmissions more securely.

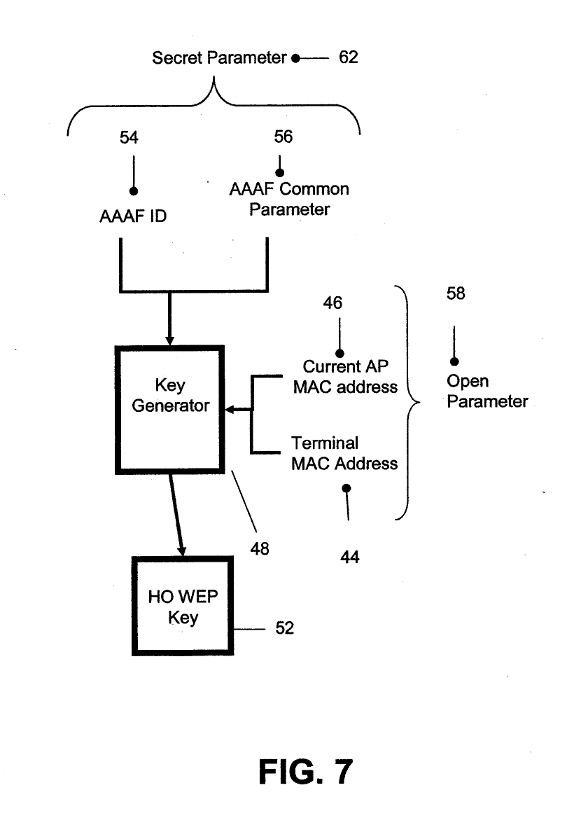

The creation of a handoff WEP key is illustrated in FIG. 7 according to one embodiment of the present invention. As an example, each access point 14, 16, and 18 under the AAAF server 32 implements a key generation process to create a single handoff WEP key 52 for each wireless terminal 12. The key generation process shown in FIG. 7 may be transferred to the access points 14, 16, and 18 by the AAAF server 32. A secret parameter 62 consists of various parameters, including an AAAF ID 54 and an AAAF common parameter 56, which are shared among the access points 14, 16, and 18 associated with the AAAF server 32. The secret parameter 62 is only known to the related access points 14, 16, and 18. The secret parameter 62 is transferred to each access point 14, 16, and 18 by a secure method, for example as a RADIUS attribute. The wireless terminal 12 may not acquire this AAAF common parameter 56, so the sub-network 10 is protected from a DoS attack.

In addition, an open parameter 58 may also be used to create the handoff WEP key 52. The open parameter 58 may be known by any wireless terminal 12. The open parameter 58 may consist of a current AP MAC address 46 and a current terminal MAC address 44. Both the secret parameter 62 and the open parameter 62 may be provided as input to a key generator 48. The key generator 48 may use a hash function, such as Hashing for Message Authentication (HMAC) message digest 5 (MD5), to create a handoff WEP key 52 for the wireless terminal 12 from the secret parameter 62 and the open parameter 58. The key generator 48 may, of course, use other hash functions to create the handoff WEP key 52, such as MD1, MD2, MD3, MD4, secure hashing algorithm 1 (SHA-1), SHA-2 or any other hash functions. The key generator 48 may be a component of the access point 14, of the AAAF server 32, of some other server, or a stand alone system.

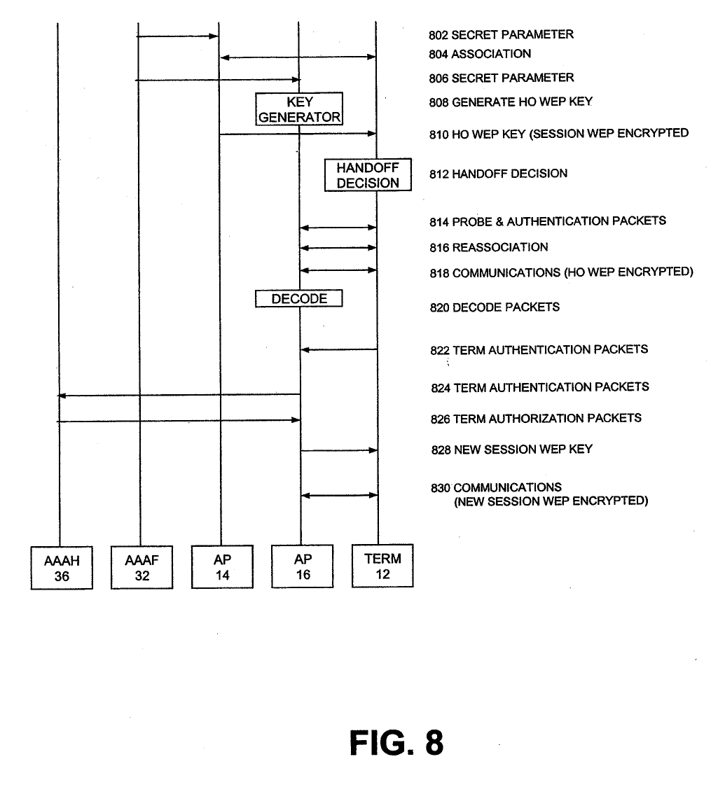

FIG. 8 is a packet communication diagram for a unique key handoff procedure according to one embodiment of the present invention, where the wireless terminal 12 hands off from access point 14 to access point 16. The steps shown in FIG. 8 are not necessarily in order of execution. At steps 802 and 806, the secret parameter 62 may be distributed to access point 14 and access point 16, respectively. For security, there should be a security association between AAAF server 32, and access points 14 and 16. In addition, the key generator 48 shown in FIG. 7 is also associated with the access points 14 and 16.

At step 804, the wireless terminal 12 is associated with access point 16. The key generator 48 generates the handoff WEP key 52 at step 808. At step 810, the access point 14 sends the handoff key 52 to the wireless terminal 12 as data encrypted by a session WEP encryption key. The wireless terminal 12 may decide to handoff from the access point 14 to the access point 16 (handoff access point) at handoff decision 812.

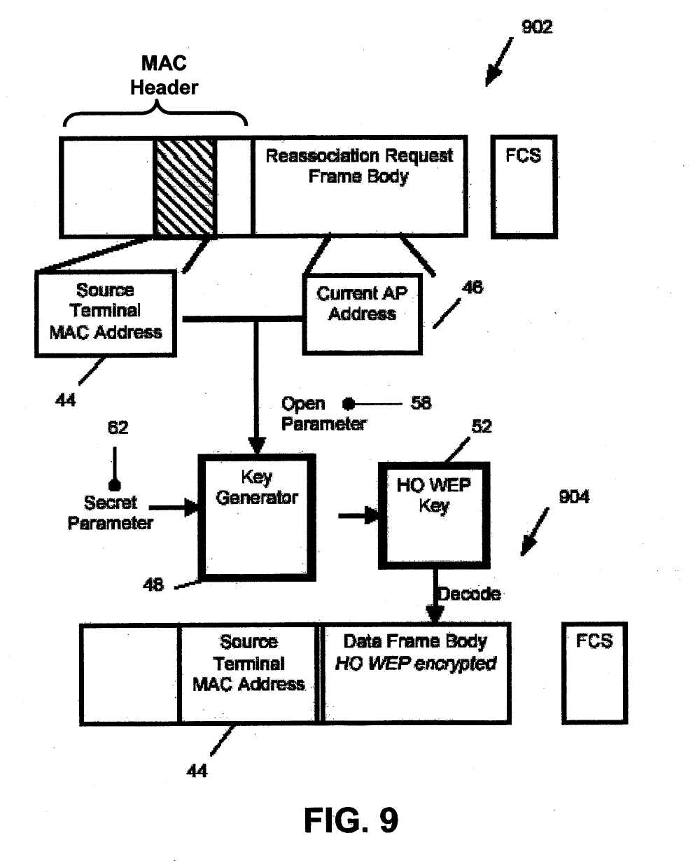

To begin the handoff, the wireless terminal 12 may exchange probe request and response packets and handoff authentication messages with the handoff access point 16 at step 814. This authentication may be an open authentication, as described above in step 412 of FIG. 4. At step 816, the wireless terminal 12 first sends a reassociation request frame 902, shown in FIG. 9, to the access point 16. From the reassociation request frame 902, the access point 16 will receive a previous AP MAC address, which is the access point 14 MAC address, and the wireless terminal 12 MAC address, as shown in FIG. 9. These MAC addresses may be used to create the handoff WEP key 52 at the access point 14, as shown in FIG. 7.

After the reassociation at step 816, data packets communicated between the wireless terminal 12 and the handoff access point 16 at step 818 may be encrypted by the handoff WEP key 52. More specifically, the wireless terminal 12 may immediately transmit its next data frame to the access point 16 after the reassociation at step 816. The data frame may be encrypted at the wireless terminal 12 by the handoff WEP key 52 that the wireless terminal 12 received from the access point 14 in step 810. Because the MAC frame header of the data frame includes the wireless terminal 12 MAC address, the access point 16 may generate the handoff WEP key 52 for this particular wireless terminal 12 by using the key generator 48. Thus, the access point 16 may decode the MAC frame at step 820 without any other communication. Furthermore, mere possession of the valid handoff WEP key 52 authenticates the wireless terminal 12 to the access point 16.

After the wireless terminal 12 and the handoff access point 16 are reassociated, the wireless terminal 12 and the access point 16 may continue to communicate data encrypted by the handoff WEP key 52 until the handoff access point 16 provides a new session WEP key. For example, the wireless terminal 12 may continue communications with the terminal 6 through the access point 16. Although temporary access for the wireless terminal 12 to the network 8 may be permitted by using handoff WEP key 52, full authentication of the wireless terminal 12 to the AAAH 36 should still be performed. This full authentication may be accomplished in steps 822, 824, 826 and 828 in the same manner as in steps 320, 322, 324 and 326 described above with reference to FIG. 3. In step 830, the wireless terminal 12 and the access point 16 may communicate data encrypted by a new session WEP key.

FIG. 9 shows the procedure for decoding with the open parameter in step 820 above according to one embodiment of the present invention. The source terminal MAC address 44 from the reassociation request frame 902 is the terminal MAC address of open parameter 58. The current access point address 46 from the frame body of the reassociation request frame 902 is the current access point MAC Address of open parameter 58. The secret parameter 62 was sent to the access point 16 in step 802, above. Therefore, all elements of the secret parameter 62 and the open parameter 58 are available to the access point 16 at the decoding step 820, so that the access point 16 may derive the handoff WEP key 52 for the terminal 12 by using the key generator 48.

On the other hand, the wireless terminal 12 does not possess the secret parameter 62, so the wireless terminal 12 may not derive the handoff WEP key 52 by itself. The wireless terminal 12 received the handoff WEP key 52 from access point 14 in step 810, after it had been fully authenticated to AAAH server 36. Because a first wireless terminal 12 may not derive the handoff WEP key 52 for a second wireless terminal 12, a hostile wireless terminal 12 will not be able to easily compromise security by a DoS attack.

Whenever a data frame 904, except for an authentication data frame, is received by the access point 16 during the handoff, the source terminal MAC address 44 is verified before the data frame 904 is decoded. Therefore, the encrypted frame body of the data frame 904 may be decoded in “real time” by the access point 16 with the handoff WEP key 52 before the wireless terminal 12 is authenticated by the AAAH server 36. The ability of the access point 16 to immediately decode the data frame 904 allows for a significant reduction in hand-off time, as compared to a system that must wait for the AAAH server 36 to authenticate the wireless terminal 12. This reduced hand-off time facilitates uninterrupted real-time communications between the wireless terminal 12 and the terminal 6 during and after a successful hand-off.

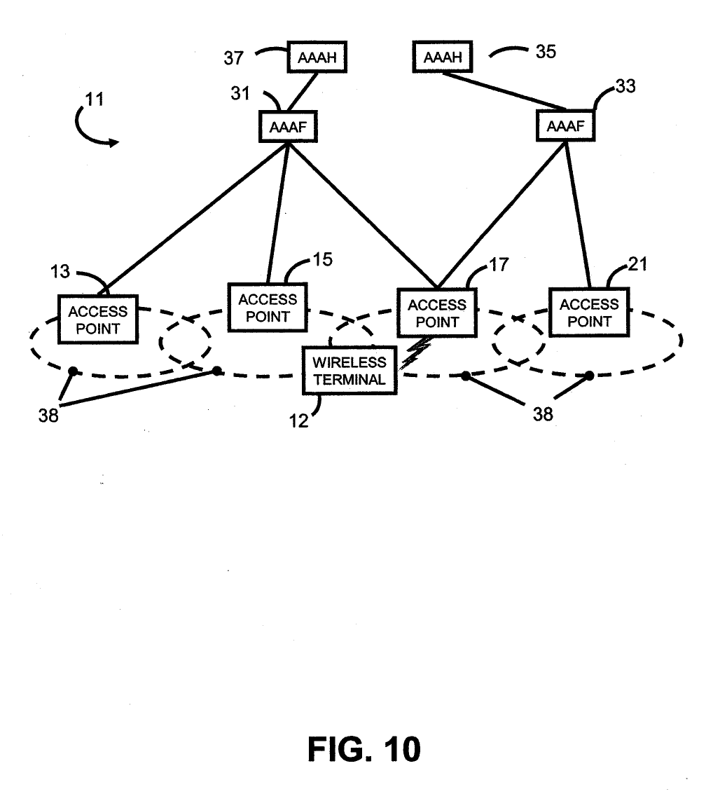

FIG. 10 is a block diagram of an illustrative sub-network 11 of the network 8 that varies slightly from the sub-network 10 shown in FIG. 2. The sub-network 11 may include AAAH servers 35 and 37, AAAF servers 31 and 33, and access points 13, 15, 17, and 21. The AAAH servers 35 and 37 may authenticate a set of terminals in the same manner as AAAH server 36. Likewise, the AAAF servers 31 and 33 may also authenticate sets of terminals in the same manner as the AAAF servers 32 and 34. Although not shown for the sake of simplicity, the sub-network 11 may also include access routers that function in the same manner as access routers 24, 26, and 28.

Unlike the sub-network 10, however, the sub-network 11 has two AAAH servers 35 and 37, rather than one. Also unlike the sub-network 10, the sub-network 11 has an access point that is associated with two AAAF servers. As shown in FIG. 10, access point 17 is associated with both of the AAAF servers 31 and 33. Furthermore, the AAAF server 31 is associated with the AAAH server 37, while the AAAF server 33 is associated with the AAAH server 35.

To implement fast handoffs throughout the sub-network 11, the access point 17 may have a security association with both of the AAAF servers 31 and 33. The access point 17 may receive handoff key generation algorithms from the AAAF servers 31 and 33. Accordingly, the wireless terminal 12 may quickly handoff from the area of the AAAF server 31 to the area of the AAAF server 33. Furthermore, the wireless terminal 12 may quickly handoff from the domain of the AAAH server 37 to the domain of the AAAH server 35.

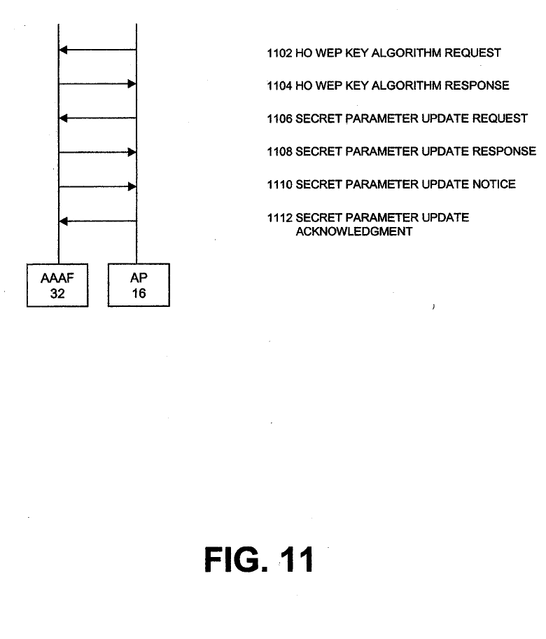

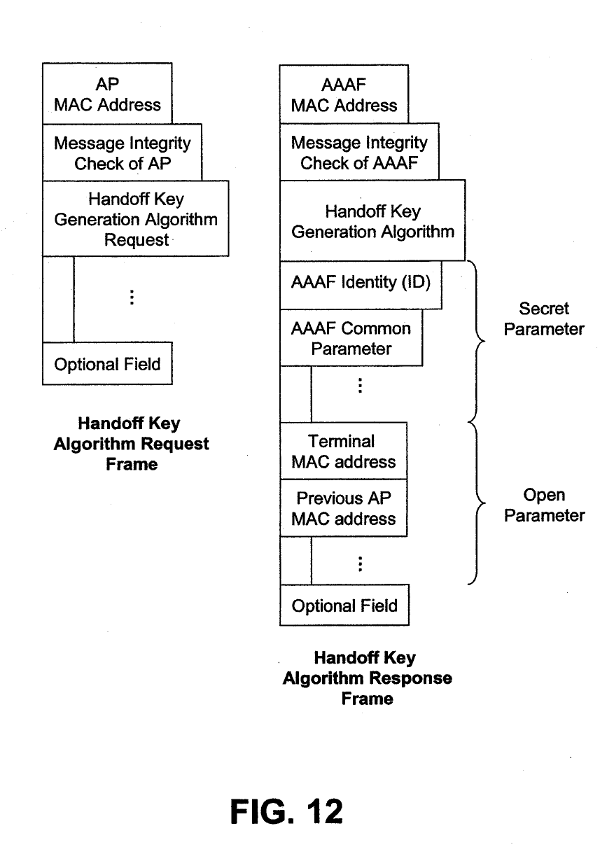

FIG. 11 is a packet communication diagram for a procedure to create and obtain the handoff WEP key 52 according to an embodiment of the present invention. In this illustrative example, packets are exchanged between the AAAF server 32 and the access point 16. At step 1102, the access point 16 sends a handoff key algorithm request frame to the AAAF server 32. An illustrative handoff key algorithm request frame according to an embodiment of the present invention is shown in FIG. 12. The AAAF server 32 will verify that the handoff key algorithm request frame is valid, for example, by analyzing an Access Point MAC Address field and a Message Integrity Check of AP field of the frame. If the request is valid, then at step 1104 the AAAF server 32 sends a handoff key algorithm response frame to the access point 16. FIG. 12 also includes an illustrative handoff key algorithm response frame.

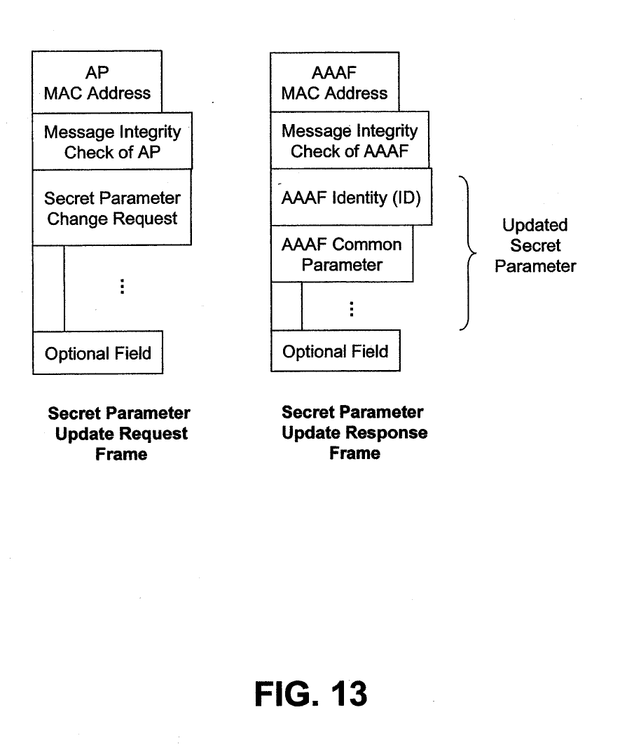

Additionally, the access point 16 may send a request to change the secret parameter, which is closely related to the handoff key generation algorithm, at step 1106. An illustrative secret parameter update request frame according to an embodiment of the present invention is shown in FIG. 13. If the request is valid, then at step 1108 the AAAF server 32 sends a secret parameter update response frame to the access point 16, which is also shown in FIG. 13. Allowing the access point 16 to initiate an update to the secret parameter in this manner may provide additional protection against a DoS attack.

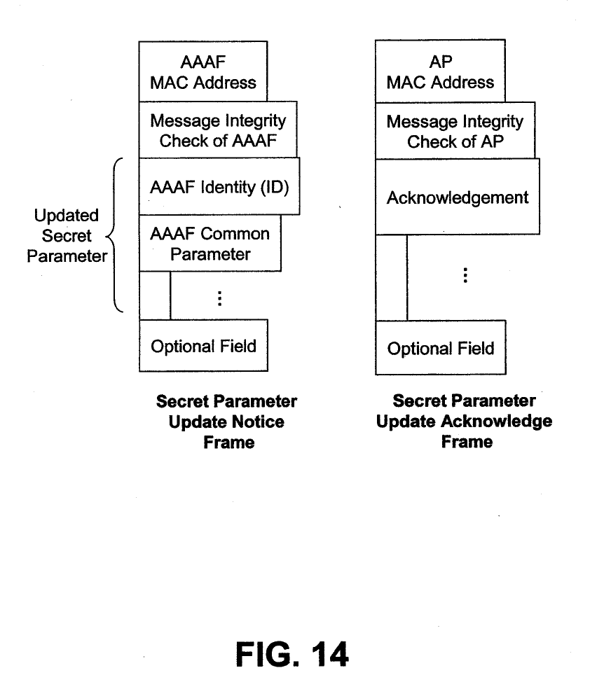

Furthermore, the AAAF server 32 may change the secret parameter with some frequency, and then send a secret parameter update notice to the access point 16 at step 1110. An illustrative secret parameter update notice frame structure according to an embodiment of the present invention is illustrated in FIG. 14. The access point 16 may acknowledge receipt of the update notice frame by sending a secret parameter update acknowledgement frame in step 1112. An illustrative secret parameter update acknowledgement frame is also shown in FIG. 14. Each of the message frames shown in FIGS. 12-14 may also include an optional field to communicate other parameters for use by the handoff key procedure.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A wireless communication network comprising:
a first authentication server operable to generate and transmit a first handoff encryption key;
a second authentication server operable to generate and transmit a second handoff encryption key;
a first access point, receiving the first handoff encryption key; and
a second access point, receiving both the first handoff encryption key and the second handoff encryption key, and decrypting encrypted data from a wireless terminal before authentication of the wireless terminal is completed.

2. The wireless communication network according to claim 1, wherein the first authentication server is an AAAF (Authentication, Authorization, and Accounting Foreign) server.

3. The wireless communication network according to claim 1, wherein the first authentication server is an AAAH (Authentication, Authorization, and Accounting Home) server.

4. The wireless communication network according to claim 3, wherein the first authentication server communicates with the first and second access points via an AAAF (Authentication, Authorization, and Accounting Foreign) server.
